(19) United States
(12) Patent Application Publication
(10) Pub. No.: US 2011/0158449 A1
(43) Pub. Date: Jun. 30, 2011

(54) Microphone Unit

(76) Inventors: Fuminori Tanaka, Osaka (JP); Ryusuke Horibe, Osaka (JP); Takeshi Inoda, Osaka (JP); Rikuo Takano, Osaka (JP); Kiyoshi Sugiyama, Osaka (JP); Toshimi Fukuoka, Kanagawa (JP); Masatoshi Ono, Ibaraki (JP)

(21) Appl. No.: 12/866,502

(22) PCT Filed: Feb. 4, 2009
(86) PCT No.: PCT/JP2009/051869

§ 371 Date: Feb. 17, 2011

(30) Foreign Application Priority Data
Feb. 8, 2008 (JP) 2008-029572

(51) Int. Cl. H04R 1/02

(52) U.S. Cl. 381/355

(57) ABSTRACT

A microphone unit (2) includes: a microphone substrate (13); and a partition unit (20) having a diaphragm (22). The microphone substrate (13) has a first substrate opening (14) and a second substrate opening (15). The partition unit (20) covers the first substrate opening (14) and the diaphragm (22) covers a part of the first substrate opening (14) so as to form an internal space containing an in-substrate unit space (12) formed at least in the microphone substrate (13) and communicating with outside from the diaphragm (22) via the first substrate opening (14) and the second substrate opening (15). This realizes a microphone unit in which a differential microphone configured by a single diaphragm is mounted with a high density.

### TECHNICAL FIELD

The present invention relates to a microphone unit.

### BACKGROUND ART

In communication by telephone or the like, voice recognition, voice recording and the like, it is preferable to collect a target voice (talker's voice) only. However, in a use environment of a voice input apparatus, there is sometimes a sound like background noise other than a target voice. Because of this, the development of voice input apparatuses, which allow an exact extraction of a target voice, that is, have a function to remove noise even in a case where the apparatuses are used in an environment where there is noise, is advancing.

Besides, in recent years, electronic apparatuses are going small, so that a technology for reducing the size of a voice input apparatus is becoming important. Patent document: JP-A-2007-81614

### DISCLOSURE OF THE INVENTION

### Problems to be Solved by the Invention

As a close-talking microphone that curbs distant noise, a differential microphone, which generates and uses a differential signal which indicates a difference between voltage signals from two microphones, is known. However, because the two microphones are used, it is hard to reduce the size of the microphone unit by mounting the differential microphone with high density, that is, by mounting the differential microphone in a small region.

The present invention has been made in light of the above situation, and it is an object of the present invention to provide a microphone unit that is size-reduced by mounting a differential microphone with high density.

### Means for Solving the Problem

A microphone unit according to the present invention is a microphone unit that includes a microphone substrate and a partition portion that has a diaphragm; and converts an input sound wave into an electrical signal by vibrating the diaphragm by means of a difference between sound pressures that act on both surfaces of the diaphragm; wherein
the microphone substrate has a first substrate opening portion and a second substrate opening portion that are disposed on one surface;
the partition portion covers the first substrate opening portion;
the diaphragm covers at least part of the first substrate opening portion; and
an internal space, which is a space including at least a substrate internal space that is formed inside the microphone substrate; and communicates from the diaphragm to outside via the first substrate opening portion and the second substrate opening portion, is formed.

The partition portion may be formed as a so-called MEMS (Micro Electro Mechanical System). Besides, the diaphragm may be a thing that uses an inorganic piezoelectric thin film or an organic piezoelectric thin film to perform sound-to-electricity conversion by means of a piezoelectric effect; or may be an electret film. Besides, the microphone substrate may be formed of an insulation molding material, sintered ceramics, glass epoxy, plastic or the like.

According to the present invention, it becomes possible to achieve a microphone unit in which a differential microphone composed of a diaphragm is mounted with high density.

(2) In the microphone unit, the substrate internal space may be disposed in a vertical direction of a region that on both ends thereof, includes the first substrate opening portion and the second substrate opening portion.

(3) The microphone unit includes a cover portion that is put on a one-surface side of the microphone substrate; wherein
the cover portion has: a first cover-portion opening portion; a second cover-portion opening portion; a third cover-portion opening portion; a fourth cover-portion opening portion; a first cover-portion internal space that connects the first cover-portion opening portion and the second cover-portion opening portion to each other; and a second cover-portion internal space that connects the third cover-portion opening portion and the fourth cover-portion opening portion to each other;
the first cover-portion internal space communicates with the outside via the first cover-portion opening portion and with the internal space via the second cover-portion opening portion; and
the second cover-portion internal space communicates with the outside via the third cover-portion opening portion and may be partitioned from the internal space by the partition portion at at least part of the fourth cover-portion opening portion.

(4) In the microphone unit, the microphone substrate may be formed by attaching a plurality of substrates to each other in such a way that the substrate internal space is formed.

(5) In the microphone unit, the microphone substrate has a third substrate opening portion disposed on the other surface; and
the internal space may connect the diaphragm and the outside to each other via the third substrate opening portion besides the first substrate opening portion and the second substrate opening portion.

(6) In the microphone unit, the substrate internal space may be disposed in a vertical direction of the third substrate opening portion.

(7) The microphone unit includes a wiring substrate; wherein
the wiring substrate is disposed on a other-surface side of the microphone substrate and so joined to the other-side surface side as to cover the third substrate opening portion.

(8) In the microphone unit, a sound-wave arrival time from the first cover-portion opening portion to the diaphragm and a sound-wave arrival time from the third cover-portion opening portion to the diaphragm may be equal to each other.

(9) The microphone unit may include a signal process circuit that is disposed on the one-surface side of the microphone substrate and in the second cover-portion internal space.

### BRIEF DESCRIPTION OF THE DRAWINGS

FIG. 1A is a diagram showing a structure of a microphone unit according to a first embodiment.

FIG. 1B is a sectional view for describing operation of the microphone unit according to the first embodiment.

FIG. 2A is a diagram showing a structural example of a microphone substrate of the microphone unit according to the first embodiment, that is, a schematic plan view showing a structure of a lower substrate of a microphone substrate that is formed by attaching two substrates to each other.

FIG. 2B is a diagram showing a structural example of the microphone substrate of the microphone unit according to the first embodiment, that is, a schematic plan view showing a structure of an upper substrate of the microphone substrate that is formed by attaching two substrates to each other.

FIG. 3 is a sectional view schematically showing a structure of a capacitor-type microphone.

FIG. 4A is a diagram showing a structure of a microphone unit according to a second embodiment.

FIG. 4B is a sectional view for describing operation of the microphone unit according to the second embodiment.

FIG. 5A is a diagram showing a structural example of a microphone substrate of the microphone unit according to the second embodiment, that is, a schematic plan view showing a structure of a lower substrate of a microphone substrate that is formed by attaching three substrates to each other.

FIG. 5B is a diagram showing a structural example of the microphone substrate of the microphone unit according to the second embodiment, that is, a schematic plan view showing a structure of an intermediate substrate of the microphone substrate that is formed by attaching three substrates to each other.

FIG. 5C is a diagram showing a structural example of the microphone substrate of the microphone unit according to the second embodiment, that is, a schematic plan view showing a structure of an upper substrate of a microphone substrate that is formed by attaching three substrates to each other.

FIG. 6 is a diagram showing another structural example of the microphone substrate of the microphone unit according to the second embodiment.

FIG. 7A is a diagram showing a structure of a microphone unit according to a third embodiment.

FIG. 7B is a sectional view for describing operation of the microphone unit according to the second embodiment.

FIG. 8A is a diagram showing a structural example of a microphone substrate of the microphone unit according to the third embodiment, that is, a schematic plan view showing a structure of a lower substrate of a microphone substrate that is formed by attaching two substrates to each other.

FIG. 8B is a diagram showing a structural example of the microphone substrate of the microphone unit according to the third embodiment, that is, a schematic plan view showing a structure of an upper substrate of the microphone substrate that is formed by attaching two substrates to each other.

FIG. 9A is a diagram showing a structure of a microphone unit according to a fourth embodiment.

FIG. 9B is a sectional view for describing operation of the microphone unit according to the fourth embodiment.

FIG. 10A is a diagram showing a structure of a microphone unit according to a fifth embodiment.

FIG. 10B is a sectional view for describing operation of the microphone unit according to the fifth embodiment.

FIG. 11A is a diagram showing a structure of a microphone unit according to a sixth embodiment.

FIG. 11B is a sectional view for describing operation of the microphone unit according to the sixth embodiment.

### LIST OF REFERENCE SYMBOLS

1-6 microphone units
10, 13, 16 microphone substrates
11 substrate opening portion
12 substrate internal space
14 first substrate opening portion
15 second substrate opening portion
17 third substrate opening portion
20 partition portion
22 diaphragm
24 hold portion
30 wiring substrate
31-32 electrodes
33 seal portion
40 cover portion
41 first cover-portion opening portion
42 second cover-portion opening portion
43 third cover-portion opening portion
44 fourth cover-portion opening portion
45 first cover-portion internal space
46 second cover-portion internal space
50 signal process circuit
200 capacitor-type microphone
202 diaphragm
204 electrode

### BEST MODE FOR CARRYING OUT THE INVENTION

Hereinafter, the embodiments to which the present invention is applied are described with reference to the drawings. However, the present invention is not limited to the following embodiments. Besides, the present invention covers a free combination of the following contents.

Here, the microphone units described hereinafter are applicable to, for example, voice communication apparatuses such as a mobile telephone, a public telephone, a transceiver, a headset and the like, or to a recording apparatus, an amplification system (loudspeaker), a microphone system and the like.

1. Microphone Unit According To First Embodiment

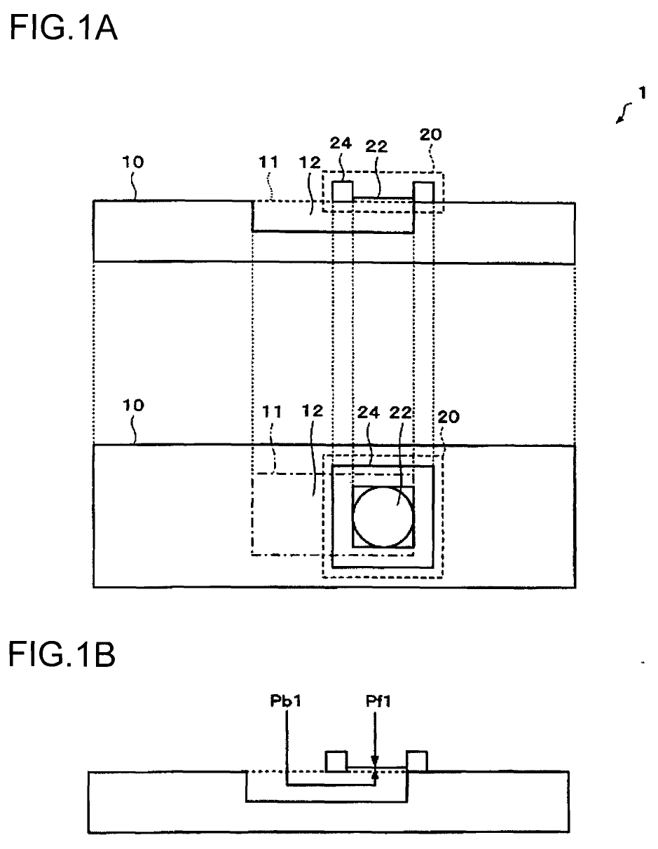

A structure of a microphone unit 1 according to a first embodiment is described with reference to FIGS. 1A, 1B, 2A, 2B and 3.

FIG. 1A is a diagram showing a structure of a microphone unit according to the first embodiment: an upper drawing is a sectional view of the microphone unit 1 according to the present embodiment; and a lower drawing is a diagram schematically showing a plan view of the microphone unit 1 according to the present embodiment.

The microphone unit 1 according to the present embodiment includes a microphone substrate, that is, a mike substrate 10. The mike substrate 10 has: a substrate opening portion 11 that faces one surface; and a substrate internal space 12 that communicates with outside via the substrate opening portion 11. The substrate internal space 12 may be disposed in a vertical direction only of the substrate opening portion 11.

The shape of the substrate internal space 12 is not especially limited and may be a rectangular parallelepiped, for example. Besides, the shape of the substrate opening portion 11 is not especially limited and may be a rectangle, for example; in a case where the substrate internal space 12 is a rectangular parallelepiped, the substrate opening portion 11 may be disposed on the entire one surface of the substrate internal space 12.

The mike substrate 10 may be formed of a material such as an insulation molding material, sintered ceramics, glass epoxy, plastic or the like. Besides, it is possible to produce the mike substrate 10 that has the substrate internal space 12: for example, by pushing a mold that has a convex portion against an insulation molding material; with sintered ceramics by using a desired mold; or by attaching a plurality of substrates some of which have a through-hole and the other of which do not have a through-hole.

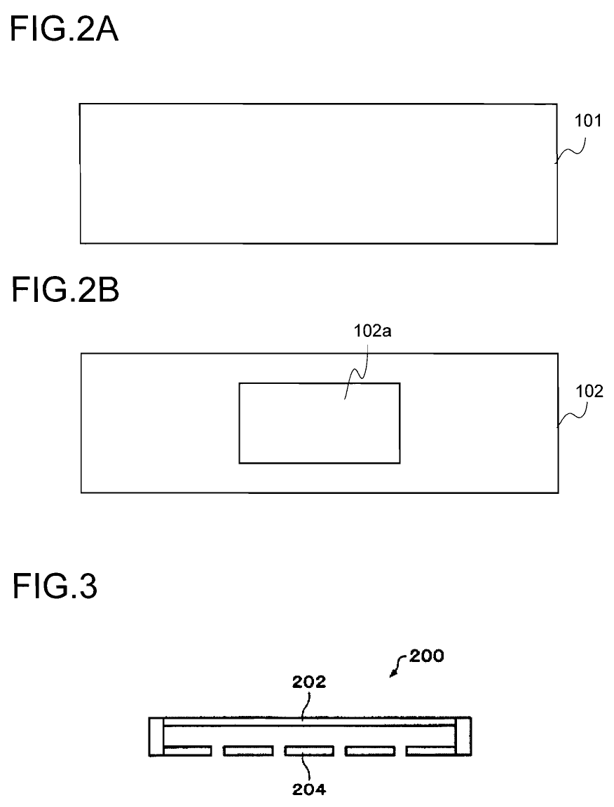

FIGS. 2A and 2B are diagrams for describing a structural example of the mike substrate 10 that is produced by attaching a plurality of substrates some of which have a through-hole and the other of which do not have a through-hole. FIG. 2A is a schematic plan view showing a structure of a lower substrate of the mike substrate 10 that is formed by attaching two substrates to each other; and FIG. 2B is a schematic plan view showing a structure of an upper substrate of the mike substrate 10 that is formed by attaching the two substrates to each other. It is possible to obtain the mike substrate 10 by attaching an upper substrate 102, which has a through-hole 102a that has substantially a rectangular shape when seen in a planar fashion, on a lower substrate 101 that dose not have a through-hole.

The microphone unit 1 according to the present embodiment includes a partition portion 20. The partition portion 20 is disposed at a position to cover part of the substrate opening portion 11.

The partition portion 20 includes a diaphragm 22 in part thereof. The diaphragm 22 is a member that vibrates in a direction of the normal when a sound wave is applied. And, in the microphone unit 1, an electrical signal is extracted based on vibration of the diaphragm 22, so that the electrical signal indicating a voice which is applied to the diaphragm 22 is obtained. In other words, the diaphragm 22 is a diaphragm of the microphone.

The diaphragm 22 is disposed at a position to cover part of the substrate opening portion 11. Here, the position of a vibration surface of the diaphragm 22 may match an opening surface of the substrate opening portion 11 or may not. Besides, the partition portion 20 may have a hold portion 24 that holds the diaphragm 22.

Hereinafter, as an example of the microphone that is applicable to the present embodiment, a structure of a capacitor-type microphone 200 is described. FIG. 3 is a sectional view schematically showing a structure of the capacitor-type microphone 200.

The capacitor-type microphone 200 has a diaphragm 202. Here, the diaphragm 202 corresponds to the diaphragm 22 of the microphone unit 1 according to the present embodiment. The diaphragm 202 is a film (thin film) that receives a sound wave to vibrate, has electrical conductivity and forms one end of an electrode. The capacitor-type microphone 200 has also an electrode 204. The electrode 204 is disposed to face and come close to the diaphragm 202. In this way, the diaphragm 202 and the electrode 204 define a capacity. When a sound wave enters the capacitor-type microphone 200, the diaphragm 202 vibrates and the distance between the diaphragm 202 and the electrode 204 changes, so that the electrostatic capacity between the diaphragm 202 and the electrode 204 changes. By capturing the change in the electrostatic capacity as a voltage change, for example, it is possible to obtain an electrical signal based on the vibration of the diaphragm 202. In other words, it is possible to convert a sound wave that enters the capacitor-type microphone 200 into an electrical signal and output the electrical signal. Here, in the capacitor-type microphone 200, the electrode 204 may have a structure that is not influenced by a sound wave. For example, the electrode 204 may have a mesh structure.

However, the microphone (diaphragm 22) to which the present invention is applicable is not limited to the capacitor-type microphone; and is applicable to any of microphones that are already well known. For example, the diaphragm 22 may be a diaphragm for various microphones such as an electrical type (dynamic type), an electro-magnetic type (magnetic type), a piezoelectric type (crystal type) and the like.

Or, the diaphragm 22 may be a semiconductor film (e.g., silicon film). In other words, the diaphragm 22 may be a diaphragm for a silicon mike (Si mike). By using a silicon mike, it is possible to achieve size reduction and high performance of the microphone unit 1.

Here, the shape of the diaphragm 22 is not especially limited. For example, the shape of the diaphragm 22 may be a circle.

FIG. 1B is a sectional view for describing operation of the microphone unit 1 according to the present embodiment.

A sound pressure Pf1 of a sound wave, which reaches the diaphragm 22 without passing through the substrate internal space 12, is applied to one surface of the diaphragm 22; a sound pressure Pb1 of a sound wave, which reaches the diaphragm 22 by passing through the substrate internal space 12, is applied to the other surface of the diaphragm 22. Accordingly, the diaphragm 22 operates based on a difference between the sound pressure Pf1 and the sound pressure Pb1. In other words, the diaphragm 22 operates as a diaphragm of a differential mike.

Accordingly, according to the microphone unit in the present embodiment, it is possible to detect a sound-pressure difference by using the sound waves, as the inputs, at the two points on the same surface of the mike substrate 10. Besides, by mounting a differential mike composed of one diaphragm with high density, it is possible to achieve a small-size, light-weight microphone unit.

2. Microphone Unit According To Second Embodiment

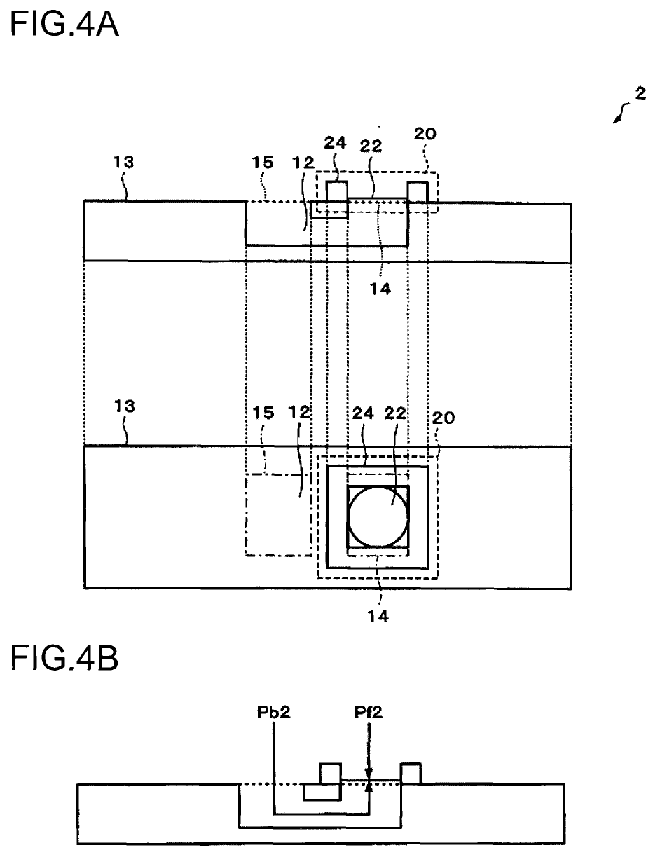

A structure of a microphone unit 2 according to a second embodiment is described with reference to FIGS. 4A, 4B, 5A to 5C and 6.

FIG. 4A is a diagram showing an example of a structure of a microphone unit according to the present embodiment: an upper drawing is a sectional view of the microphone unit 2 according to the present embodiment; a lower drawing is a diagram schematically showing a plan view of the microphone unit 2 according to the present embodiment. Here, the same structures as those of the microphone unit 1 that is described by using FIG. 1A are indicated by the same reference numbers; and detailed description of them is skipped.

The microphone unit 2 according to the present embodiment includes a mike substrate 13. The mike substrate 13 has: a first substrate opening portion 14 and a second substrate opening portion 15 that face one surface; and the substrate internal space 12 that communicates with outside via the first substrate opening portion 14 and the second substrate opening portion 15. The substrate internal space 12 may be disposed in a vertical direction only of a region that at both ends thereof, includes the first substrate opening portion 14 and the second substrate opening portion 15.

The shape of the substrate internal space 12 is not especially limited and may be a rectangular parallelepiped, for example. Besides, the shapes of the first substrate opening portion 14 and the second substrate opening portion 15 are not especially limited and may be a circle or a rectangle, for example. Further, in a case where the substrate internal space 12 is a rectangular parallelepiped, the first substrate opening portion 14 and the second substrate opening portion 15 may be disposed at both ends of one surface of the substrate internal space 12.

The mike substrate 13 may be formed of a material such as an insulation molding material, sintered ceramics, glass epoxy, plastic or the like. Besides, it is possible to produce the mike substrate 13 that has the substrate internal space 12, for example, by attaching a plurality of substrates some of which have a through-hole and the other of which do not have a through-hole.

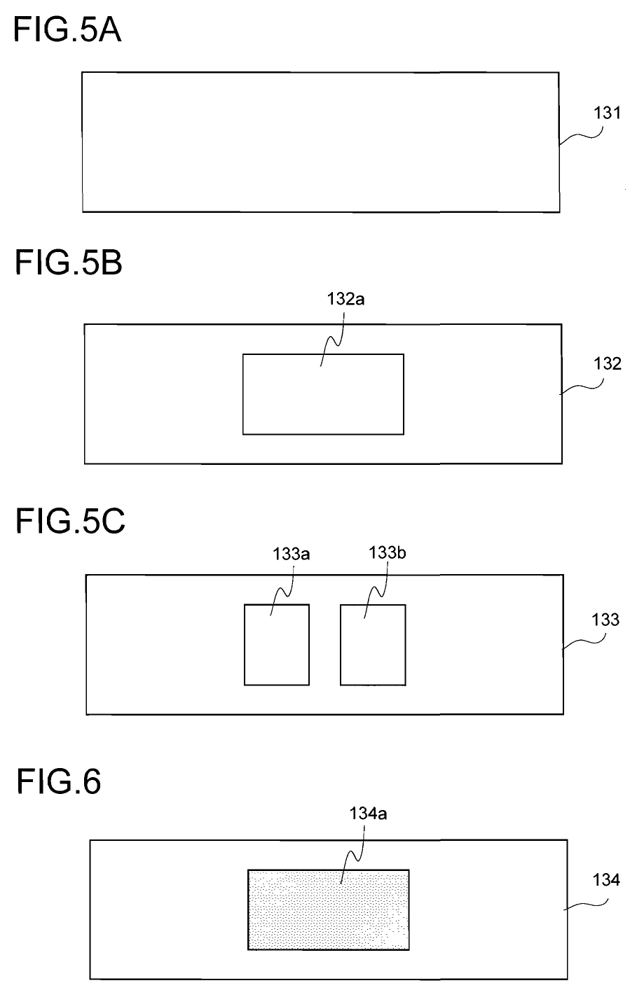

FIGS. 5A and 5C are diagrams for describing a structural example of the mike substrate 13 which is produced by attaching a plurality of substrates some of which have a through-hole and the other of which do not have a through-hole. FIG. 5A is a schematic plan view showing a structure of a lower substrate of the mike substrate 13 that is formed by attaching three substrates to each other; FIG. 5B is a schematic plan view showing a structure of an intermediate substrate of the mike substrate 13 that is formed by attaching the three substrates to each other; and FIG. 5C is a schematic plan view showing a structure of an upper substrate of the mike substrate 13 that is formed by attaching the three substrates to each other. It is possible to obtain the mike substrate 13 by attaching an intermediate substrate 132, which has a through-hole 132a that has substantially a rectangular shape when seen in a planar fashion, on a lower substrate 131 that dose not have a through-hole; and further by attaching an upper substrate 133, which has two through-holes 133a, 133b that have substantially a rectangular shape when seen in a planar fashion.

Here, instead of preparing the lower substrate 131 and the intermediate substrate 132, by preparing a lower substrate 134, as the substrate that does not have a through-hole, which has a groove portion 134a that has substantially a rectangular shape when seen in a planar fashion as shown in FIG. 6; and the mike substrate 13 may be obtained by attaching the above upper substrate 133 that has the two through-holes 133a, 133b to the lower substrate 134.

The microphone unit 2 according to the present embodiment includes the partition portion 20. The partition portion 20 is disposed at a position to cover the entire first substrate opening portion 14. The structure of the partition portion 20 is the same as the microphone unit 1 that is described by using FIG. 1A. The diaphragm 22 of the partition portion 20 is disposed at a position to cover part of the first substrate opening portion 14. Here, the position of the vibration surface of the diaphragm 22 may match the opening surface of the first substrate opening portion 14 or may not.

FIG. 4B is a sectional view for describing operation of the microphone unit 2 according to the present embodiment.

A sound pressure Pf2 of a sound wave, which reaches the diaphragm 22 without passing through the substrate internal space 12, is applied to one surface of the diaphragm 22; a sound pressure Pb2 of a sound wave, which reaches the diaphragm 22 by passing through the substrate internal space 12, is applied to the other surface of the diaphragm 22. Accordingly, the diaphragm 22 operates based on a difference between the sound pressure Pf2 and the sound pressure Pb2. In other words, the diaphragm 22 operates as a diaphragm of a differential mike.

Here, to obtain a good differential-mike characteristic, adhesion between the mike substrate 13 and the hold portion 24 becomes important. If there is an acoustic leak between the mike substrate 13 and the hold portion 24, the sound pressure that enters from the second substrate opening portion 15 cannot reach the diaphragm 22 and it is impossible to obtain a good differential-mike characteristic. In the present embodiment, all the four edges of a lower surface of the hold portion 24 that holds the diaphragm 22 are in tight contact with an upper surface of the mike substrate 13, in other words, an acoustic-leak measure for this one surface is taken by means of a seal member or the like, it is possible to obtain a good differential-mike characteristic without unevenness and it is possible to obtain a microphone unit that is also resistant to an environmental change.

Accordingly, according to the microphone unit in the present embodiment, it is possible to detect the sound-pressure difference by using the sound waves, as the inputs, at the two points on the same surface of the mike substrate 13. Besides, by mounting a differential mike composed of one diaphragm with high density, it is possible to achieve a small-size, light-weight microphone unit.

3. Microphone Unit According To Third Embodiment

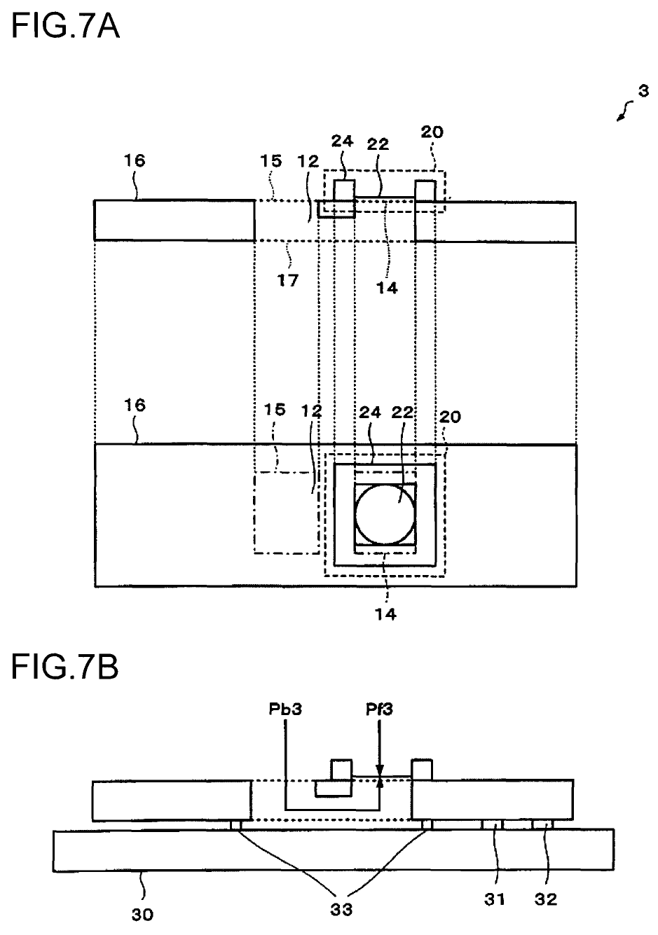

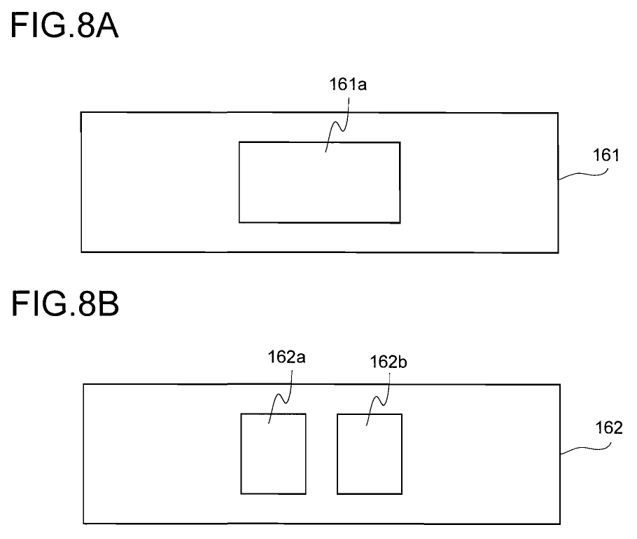

A structure of a microphone unit 3 according to a third embodiment is described with reference to FIGS. 7A, 7B, 8A and 8B.

FIG. 7A is a diagram showing an example of a structure of a microphone unit according to the present embodiment: an upper drawing is a sectional view of the microphone unit 3 according to the present embodiment; a lower drawing is a diagram schematically showing a plan view of the microphone unit 3 according to the present embodiment. Here, the same structures as those of the microphone unit 1 that is described by using FIG. 1A and the microphone unit 2 that is described by using FIG. 4A are indicated by the same reference numbers; and detailed description of them is skipped.

The microphone unit 3 according to the present embodiment includes a mike substrate 16. The mike substrate 16 has: the first substrate opening portion 14 and the second substrate opening portion 15 that face one surface; a third substrate opening portion 17 that faces the other surface; and the substrate internal space 12 that communicates with outside via the first substrate opening portion 14, the second substrate opening portion 15 and the third substrate opening portion 17. The substrate internal space 12 may be disposed in a vertical direction only of the third substrate opening portion 17.

The shape of the substrate internal space 12 is not especially limited and may be a rectangular parallelepiped, for example. Besides, the shapes of the first substrate opening portion 14, the second substrate opening portion 15 and the third substrate opening portion 17 are not especially limited and may be a circle or a rectangle, for example. Moreover, in a case where the internal space 12 is a rectangular parallelepiped, the first substrate opening portion 14 and the second substrate opening portion 15 may be disposed at both ends of one of opposite surfaces of the rectangular parallelepiped; and the third substrate opening portion 17 may be disposed on the other of the opposite surfaces of the rectangular parallelepiped. Besides, in the case where the substrate internal space 12 is a rectangular parallelepiped, the entire one surface of the substrate internal space 12 may be the third substrate opening portion 17.

The mike substrate 16 may be formed of a material such as an insulation molding material, sintered ceramics, glass epoxy, plastic or the like. Besides, it is possible to produce the mike substrate 16 that has the substrate internal space 12: for example, by pushing a mold that has a convex portion against an insulation molding material and by forming a through-hole after the producing; with sintered ceramics by using a desired mold and by forming a through-hole after the producing; or by attaching substrates which have a through-hole arranged differently from each other.

FIGS. 8A and 8B are diagrams for describing a structural example of the mike substrate 16 which is produced by attaching substrates which have a through-hole arranged differently from each other. FIG. 8A is a schematic plan view showing a structure of a lower substrate of the mike substrate 16 that is formed by attaching two substrates to each other; and FIG. 8B is a schematic plan view showing a structure of an upper substrate of the mike substrate 16 that is formed by attaching the two substrates to each other. It is possible to obtain the mike substrate 16 by attaching the upper substrate 162, which has two through-holes 162a, 162b that have substantially a rectangular shape when seen in a planar fashion, on a lower substrate 161 which has a through-hole that has substantially a rectangular shape when seen in a planar fashion.

The microphone unit 3 according to the present embodiment includes the partition portion 20. The partition portion 20 is disposed at a position to cover the entire first substrate opening portion 14. The structure of the partition portion 20 is the same as the microphone unit 1 that is described by using FIG. 1A and as the microphone unit 2 that is described by using FIG. 4A. Here, the position of the vibration surface of the diaphragm 22 may match the opening surface of the first substrate opening portion 14 or may not.

The microphone unit 3 according to the present embodiment, as shown in FIG. 7B, may join to a wiring substrate 30. The wiring substrate 30 holds the mike substrate 16 and on which a wiring and the like, which guide an electrical signal based on the vibration of the diaphragm 22 to other circuits, are formed. Besides, the microphone unit 3 according to the present embodiment may include electrodes 31 and 32 that are used to guide an electrical signal based on the vibration of the diaphragm 22 to the wiring substrate 30. Here, the two electrodes are shown in FIG. 7B; however, the shape and number of electrodes are not especially limited.

In the microphone unit 3 according to the present embodiment, as shown in FIG. 7B, the third substrate opening portion 17 is able to be blocked by joining to the wiring substrate 30; and it becomes possible to use the substrate internal space 12 as a sound-wave route.

The wiring substrate 30 may be joined to a region that surrounds the third substrate opening portion 17 in all directions on the other surface of the mike substrate 16. For example, the wiring substrate 30 may include a seal portion 33 that surrounds, without discontinuity, a circumference of the third substrate opening portion 17 on the other surface of the mike substrate 16 and joins the mike substrate 16 and the wiring substrate 30 to each other. In this way, it is possible to prevent a voice (acoustic leak) from entering the third substrate opening portion 17 via a gap between the mike substrate 16 and the wiring substrate 30.

The seal portion 33 may be formed of solder, for example. Besides, for example, the seal portion 33 may be formed of an electro-conductive adhesive such as silver paste or the like or of an adhesive that does not especially have electrical conductivity. Besides, for example, the seal portion 33 may be formed of a material such as an adhesive seal or the like that is able to secure air-tightness.

Next, operation of the microphone unit 3 according to the present embodiment is described by using FIG. 7B.

A sound pressure Pf3 of a sound wave, which reaches the diaphragm 22 without passing through the internal space 12, is applied to one surface of the diaphragm 22; a sound pressure Pb3 of a sound wave, which reaches the diaphragm 22 by passing through the internal space 12, is applied to the other surface of the diaphragm 22. Accordingly, the diaphragm 22 operates based on a difference between the sound pressure Pf3 and the sound pressure Pb3. In other words, the diaphragm 22 operates as a diaphragm of a differential mike.

Here, to obtain a good differential-mike characteristic, adhesion between the mike substrate 16 and the hold portion 24 becomes important. If there is an acoustic leak between the mike substrate 16 and the hold portion 24, the sound pressure that enters from the second substrate opening portion 15 cannot reach the diaphragm 22 and it is impossible to obtain a good differential-mike characteristic. In the present embodiment, in the first substrate opening portion 14, all the four edges of the lower surface of the hold portion 24 that holds the diaphragm 22 are in tight contact with an upper surface of the mike substrate 16, in other words, an acoustic-leak measure for this one surface is taken by means of a seal member or the like, it is possible to obtain a good differential-mike characteristic without unevenness and it is possible to obtain a microphone unit that is also resistant to an environmental change.

Moreover, as for the mike substrate 16, by blocking the third substrate opening portion 17 by means of the wiring substrate 30 to secure the substrate internal space 12, a member like the mike substrate 13 shown in the second embodiment that seals the lower portion of the substrate internal space 12 becomes unnecessary, so that it is possible to curb the thickness of the mike substrate and it is possible to achieve the thin microphone unit 3.

Accordingly, according to the microphone unit in the present embodiment, it is possible to detect the sound-pressure difference by using the sound waves, as the inputs, at the two points on the same surface of the mike 16. Besides, by mounting a differential mike composed of one diaphragm with high density, it is possible to achieve a small-size, light-weight microphone unit.

4. Microphone Unit According To Fourth Embodiment

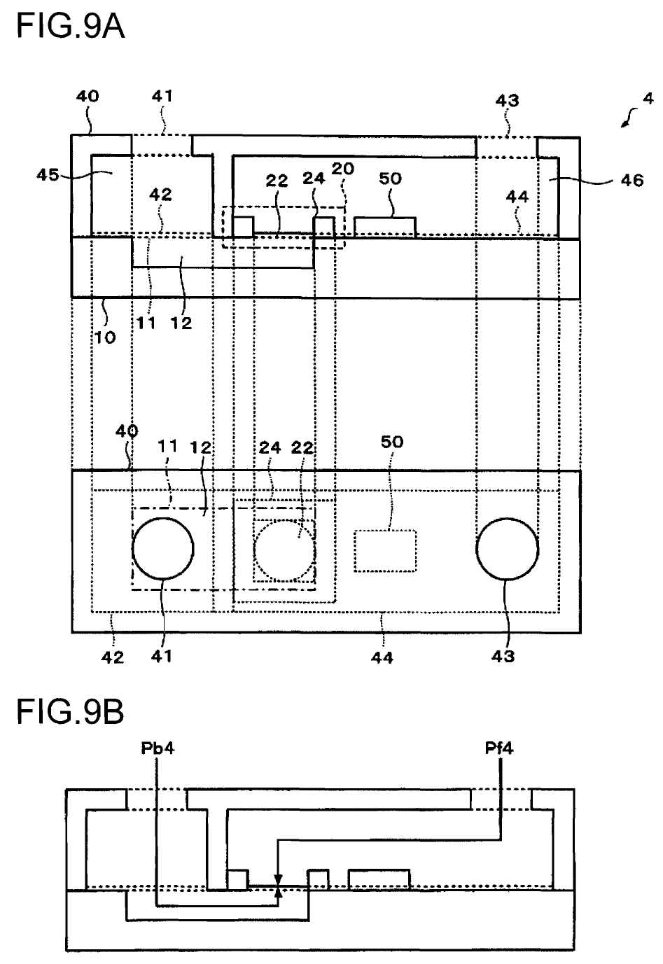

A structure of a microphone unit 4 according to a fourth embodiment is described with reference to FIGS. 9A and 9B.

FIG. 9A is a diagram showing an example of a structure of a microphone unit according to the present embodiment: an upper drawing is a sectional view of the microphone unit 4 according to the present embodiment; a lower drawing is a diagram schematically showing a plan view of the microphone unit 4 according to the present embodiment. Here, the same structures as those of the microphone unit 1 that is described by using FIG. 1A are indicated by the same reference numbers; and detailed description of them is skipped.

The microphone unit 4 according to the present embodiment includes the mike substrate 10. The mike substrate 10 has: the substrate opening portion 11 that faces one surface; and the substrate internal space 12 that communicates with outside via the substrate opening portion 11. The substrate internal space 12 may be disposed in the vertical direction only of the substrate opening portion 11. Besides, the microphone unit 4 according to the present embodiment includes the partition portion 20. The partition portion 20 is disposed at the position to cover part of the substrate opening portion 11. Besides, the diaphragm 22 of the partition portion 20 is disposed at the position to cover part of the substrate opening portion. These structures are the same as the microphone unit 1 that is described by using FIG. 1A.

The microphone unit 4 according to the present embodiment includes a cover portion 40 that is put on a one-surface side of the mike substrate 10. The cover portion 40 has: a first cover-portion opening portion 41; a second cover-portion opening portion 42; a third cover-portion opening portion 43; a fourth cover-portion opening portion 44; a first cover-portion internal space 45 that connects the first cover-portion opening portion 41 and the second cover-portion opening portion 42 to each other; and a second cover-portion internal space 46 that connects the third cover-portion opening portion 43 and the fourth cover-portion opening portion 44 to each other.

The first cover-portion internal space 45 communicates with outside via the first cover-portion opening portion 41 and with the substrate internal space 12 via the second cover-portion opening portion 42. The shapes of the first cover-portion opening portion 41 and the second cover-portion opening portion 42 are not especially limited and may be a rectangle or a circle, for example. Besides, part of the second cover-portion opening portion 42 may face one surface of the mike substrate 10.

The second cover-portion internal space 46 communicates with outside via the third cover-portion opening portion 43 and partitioned from the substrate internal space 12 by the partition portion 20 at at least part of the fourth cover-portion opening portion 44. The shapes of the third cover-portion opening portion 43 and the fourth cover-portion opening portion 44 are not especially limited and may be a rectangle or a circle, for example. Besides, part of the fourth cover-portion opening portion 44 may face one surface of the mike substrate 10.

The microphone unit 4 according to the present embodiment may include a signal process circuit 50. The signal process circuit 50 performs processes such as amplification of a signal that is based on the vibration of the diaphragm 22 and the like. The signal process circuit 50 may be disposed on the one-surface side that is part of the mike substrate 10 and in the second cover-portion internal space 46. It is preferable that the signal process circuit 50 is disposed near the diaphragm 22. In a case where the signal based on the vibration of the diaphragm 22 is weak, it is possible to increase SNR (Signal to Noise Ratio) by curbing the influence of external electro-magnetic noise as small as possible. Besides, the signal process circuit 50 may have a structure that incorporates not only an amplification circuit but also an AD converter and the like and performs a digital output.

FIG. 9B is a sectional view for describing operation of the microphone unit 4 according to the present embodiment.

A sound pressure Pf4 of a sound wave, which enters from the third cover-portion opening portion 43, passes through the second cover-portion internal space 46 and reaches the diaphragm 22, is applied to one surface of the diaphragm 22; a sound pressure Pb4 of a sound wave, which enters from the first cover-portion opening portion 41, passes through the first cover-portion internal space 45 and the substrate internal space 12, and reaches the diaphragm 22, is applied to the other surface of the diaphragm 22. Accordingly, the diaphragm 22 operates based on a difference between the sound pressure Pf4 and the sound pressure Pb4. In other words, the diaphragm 22 operates as a diaphragm of a differential mike.

Accordingly, according to the microphone unit in the present embodiment, it is possible to detect the sound-pressure difference by using the sound waves, as the inputs, at the two points on the cover portion 40, that is, at the first cover-portion opening portion 41 and the third cover-portion opening portion 43. Besides, by mounting a differential mike composed of one diaphragm with high density, it is possible to achieve a small-size, light-weight microphone unit.

Besides, a structure may be employed, in which the sound-wave arrival time from the first cover-portion opening portion 41 to the diaphragm 22 and the sound-wave arrival time from the third cover-portion opening portion 43 to the diaphragm 22 become equal to each other. To equalize the sound-wave arrival times to each other, a structure may be employed, in which for example, a sound-wave route length from the first cover-portion opening portion 41 to the diaphragm 22 and a sound-wave route length from the third cover-portion opening portion 43 to the diaphragm 22 become equal to each other. The route length may be, for example, the length of a line that connects the center of a section of the route. Preferably, the ratio between the route lengths is ±20% (a range of 80% or higher to 120% or lower) and equal, so that the acoustic impedances are nearly equal, and it is possible to improve a differential-mike characteristic in especially a high-frequency band.

According to this structure, it is possible to match the sound-wave arrival times, that is, the phases, from the first cover-portion opening portion 41 to the diaphragm 22 and from the third cover-portion opening portion 43 to the diaphragm 22 with each other and to achieve a higher-accuracy noise removal function.

5. Microphone Unit According To Fifth Embodiment

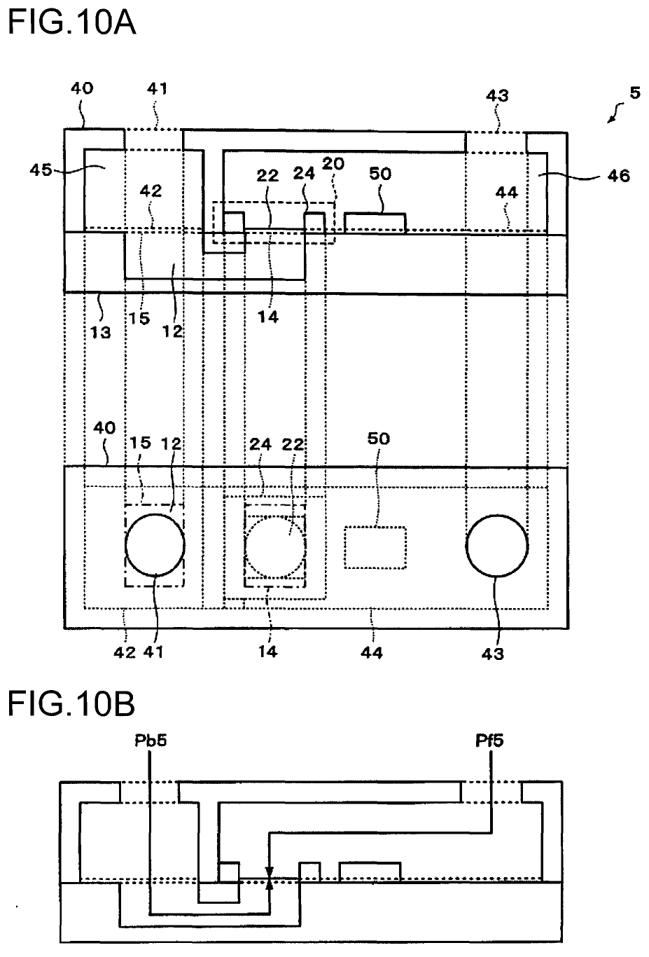

A structure of a microphone unit 5 according to a fifth embodiment is described with reference to FIGS. 10A and 10B.

FIG. 10A is a diagram showing an example of a structure of a microphone unit according to the present embodiment: an upper drawing is a sectional view of the microphone unit 5 according to the present embodiment; a lower drawing is a diagram schematically showing a plan view of the microphone unit 5 according to the present embodiment. Here, the same structures as those of the microphone unit 2 that is described by using FIG. 4A and the microphone unit 4 that is described by using FIG. 9A are indicated by the same reference numbers; and detailed description of them is skipped.

The microphone unit 5 according to the present embodiment includes the mike substrate 13. The mike substrate 13 has: the first substrate opening portion 14 and the second substrate opening portion 15 that face one surface; and the substrate internal space 12 that communicates with outside via the first substrate opening portion 14 and the second substrate opening portion 15. The substrate internal space 12 may be disposed in the vertical direction only of the region that at both ends thereof, includes the first substrate opening portion 14 and the second substrate opening portion 15. Besides, the microphone unit 5 according to the present embodiment includes the partition portion 20. The partition portion 20 is disposed at the position to cover the entire first substrate opening portion 14. Besides, the diaphragm 22 of the partition portion 20 is disposed at the position to cover part of the first substrate opening portion 14. These structures are the same as the microphone unit 2 that is described by using FIG. 4A.

The microphone unit 5 according to the present embodiment includes the cover portion 40 that is put on a one-surface side of the mike substrate 13. The cover portion 40 has: the first cover-portion opening portion 41; the second cover-portion opening portion 42; the third cover-portion opening portion 43; the fourth cover-portion opening portion 44; the first cover-portion internal space 45; and the second cover-portion internal space 46. Besides, the microphone unit 5 according to the present embodiment may include the signal process circuit 50. These structures are the same as the microphone unit 4 that is described by using FIG. 9A.

FIG. 10B is a sectional view for describing operation of the microphone unit 5 according to the present embodiment.

A sound pressure Pf5 of a sound wave, which enters from the third cover-portion opening portion 43, passes through the second cover-portion internal space 46 and reaches the diaphragm 22, is applied to one surface of the diaphragm 22; a sound pressure Pb5 of a sound wave, which enters from the first cover-portion opening portion 41, passes through the first cover-portion internal space 45 and the substrate internal space 12, and reaches the diaphragm 22, is applied to the other surface of the diaphragm 22. Accordingly, the diaphragm 22 operates based on a difference between the sound pressure Pf5 and the sound pressure Pb5. In other words, the diaphragm 22 operates as a diaphragm of a differential mike.

Here, to obtain a good differential-mike characteristic, the adhesion between the mike substrate 13 and the hold portion 24 becomes important. If there is an acoustic leak between the mike substrate 13 and the hold portion 24, the sound pressure that enters from the second substrate opening portion 15 cannot reach the diaphragm 22 and it is impossible to obtain a good differential-mike characteristic. In the present embodiment, in the first substrate opening portion 14, all the four edges of the lower surface of the hold portion 24 that holds the diaphragm 22 are in tight contact with then upper surface of the mike substrate 13, an acoustic-leak measure for this one surface is taken by means of a seal member or the like, it is possible to obtain a good differential-mike characteristic without unevenness and it is possible to obtain a microphone unit that is also resistant to an environmental change.

Accordingly, according to the microphone unit in the present embodiment, it is possible to detect the sound-pressure difference by using the sound waves, as the inputs, at the two points on the cover portion 40, that is, at the first cover-portion opening portion 41 and the third cover-portion opening portion 43. Besides, by mounting a differential mike composed of one diaphragm with high density, it is possible to achieve a small-size, light-weight microphone unit.

Besides, a structure may be employed, in which the sound-wave arrival time from the first cover-portion opening portion 41 to the diaphragm 22 and the sound-wave arrival time from the third cover-portion opening portion 43 to the diaphragm 22 become equal to each other. To equalize the sound-wave arrival times to each other, a structure may be employed, in which for example, the sound-wave route length from the first cover-portion opening portion 41 to the diaphragm 22 and the sound-wave route length from the third cover-portion opening portion 43 to the diaphragm 22 become equal to each other. The route length may be, for example, the length of a line that connects the center of a section of the route. Preferably, the ratio of the route length is ±20% (a range of 80% or higher to 120% or lower) and equal, so that the acoustic impedances are nearly equal, and it is possible to improve a differential-mike characteristic in especially a high-frequency band.

According to this structure, it is possible to match the sound-wave arrival times, that is, the phases, from the first cover-portion opening portion 41 to the diaphragm 22 and from the third cover-portion opening portion 43 to the diaphragm 22 with each other and to achieve a higher-accuracy noise removal function.

6. Microphone Unit According To Sixth Embodiment

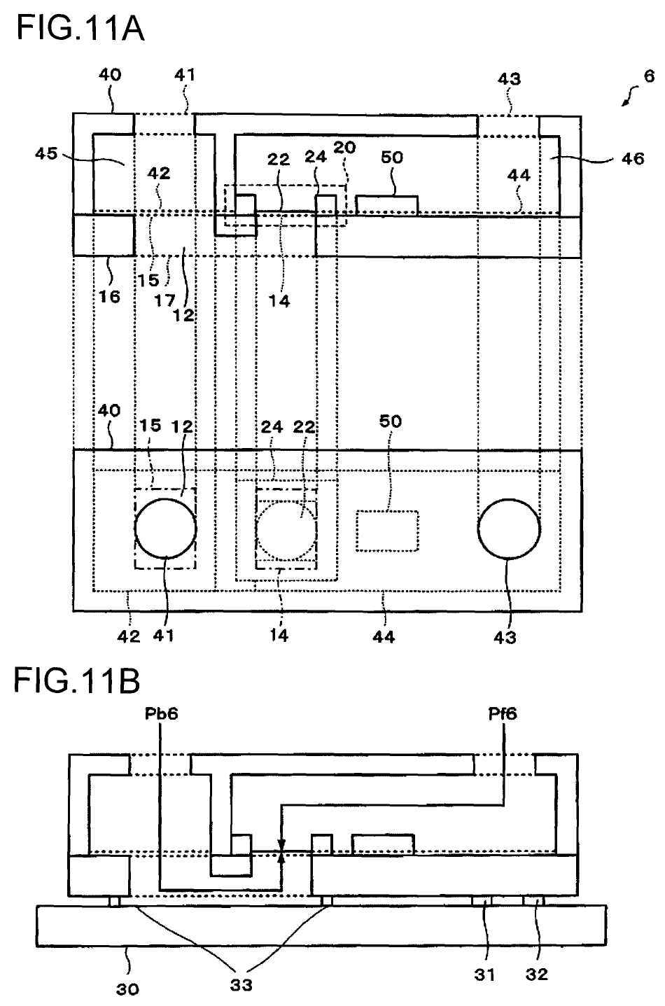

A structure of a microphone unit 6 according to a sixth embodiment is described with reference to FIGS. 11A and 11B.

FIG. 11A is a diagram showing an example of a structure of a microphone unit according to the present embodiment: an upper drawing is a sectional view of the microphone unit 6 according to the present embodiment; a lower drawing is a diagram schematically showing a plan view of the microphone unit 6 according to the present embodiment. Here, the same structures as those of the microphone unit 3 that is described by using FIG. 7A and the microphone unit 4 that is described by using FIG. 9A are indicated by the same reference numbers; and detailed description of them is skipped.

The microphone unit 6 according to the present embodiment includes the mike substrate 16. The mike substrate 16 has: the first substrate opening portion 14 and the second substrate opening portion 15 that face one surface; a third substrate opening portion 17 that face the other surface; and the substrate internal space 12 that communicates with outside via the first substrate opening portion 14, the second substrate opening portion 15 and the third substrate opening portion 17. The substrate internal space 12 may be disposed in the vertical direction only of the third substrate opening portion 17. Besides, the microphone unit 6 according to the present embodiment includes the partition portion 20. The partition portion 20 is disposed at the position to cover the entire first substrate opening portion 14. Besides, the diaphragm 22 of the partition portion 20 is disposed at the position to cover part of the first substrate opening portion 14. These structures are the same as the microphone unit 3 that is described by using FIG. 7A.

The microphone unit 6 according to the present embodiment includes the cover portion 40 that is put on a one-surface side of the mike substrate 16. The cover portion 40 has: the first cover-portion opening portion 41; the second cover-portion opening portion 42; the third cover-portion opening portion 43; the fourth cover-portion opening portion 44; the first cover-portion internal space 45; and the second cover-portion internal space 46. Besides, the microphone unit 6 according to the present embodiment may include the signal process circuit 50. These structures are the same as the microphone unit 4 that is described by using FIG. 9A.

The microphone unit 6 according to the present embodiment, as shown in FIG. 11B, may join to the wiring substrate 30. The wiring substrate 30 holds the mike substrate 16 and on which the wiring and the like, which guide an electrical signal based on the vibration of the diaphragm 22 to other circuits, are formed. Besides, the microphone unit 6 according to the present embodiment may include the electrodes 31 and 32 that are used to guide an electrical signal based on the vibration of the diaphragm 22 to the wiring substrate 30. Here, the two electrodes are shown in FIG. 11B; however, the shape and number of electrodes are not especially limited.

In the microphone unit 6 according to the present embodiment, as shown in FIG. 11B, the third substrate opening portion 17 is able to be blocked by joining to the wiring substrate 30; and it becomes possible to use the substrate internal space 12 as a sound-wave route.

The wiring substrate 30 may be joined to the region that surrounds the third substrate opening portion 17 in all directions on the other surface of the mike substrate 16. For example, the wiring substrate 30 may include the seal portion 33 that surrounds, without discontinuity, the circumference of the third substrate opening portion 17 on the other surface of the mike substrate 16 and joins the mike substrate 16 and the wiring substrate 30 to each other. In this way, it is possible to prevent a voice (acoustic leak) from entering the third substrate opening portion 17 via the gap between the mike substrate 16 and the wiring substrate 30.

The seal portion 33 may be formed of solder, for example. Besides, for example, the seal portion 33 may be formed of an electro-conductive adhesive such as silver paste or the like or of an adhesive that does not have electrical conductivity. Besides, for example, the seal portion 33 may be formed of a material such as an adhesive seal or the like that is able to secure air-tightness.

Next, operation of the microphone unit 6 according to the present embodiment is described by using FIG. 11B.

A sound pressure Pf6 of a sound wave, which enters from the third cover-portion opening portion 43, passes through the second cover-portion internal space 46 and reaches the diaphragm 22, is applied to one surface of the diaphragm 22; a sound pressure Pb6 of a sound wave, which enters from the first cover-portion opening portion 41, passes through the first cover-portion internal space 45 and the substrate internal space 12, and reaches the diaphragm 22, is applied to the other surface of the diaphragm 22. Accordingly, the diaphragm 22 operates based on a difference between the sound pressure Pf6 and the sound pressure Pb6. In other words, the diaphragm 22 operates as a diaphragm of a differential mike.

Here, to obtain a good differential-mike characteristic, the adhesion between the mike substrate 16 and the hold portion 24 becomes important. If there is an acoustic leak between the mike substrate 16 and the hold portion 24, the sound pressure that enters from the second substrate opening portion 15 cannot reach the diaphragm 22 and it is impossible to obtain a good differential-mike characteristic. In the present embodiment, in the first substrate opening portion 14, all the four edges of the lower surface of the hold portion 24 that holds the diaphragm 22 are in tight contact with the upper surface of the mike substrate 16, an acoustic-leak measure for this one surface is taken by means of a seal member or the like, it is possible to obtain a good differential-mike characteristic without unevenness and it is possible to obtain a microphone unit that is also resistant to an environmental change.

Moreover, as for the mike substrate 16, by blocking the third substrate opening portion 17 by means of the wiring substrate 30 to secure the substrate internal space 12, the member like the mike substrate 13 shown in the fifth embodiment that seals the lower portion of the substrate internal space 12 becomes unnecessary, so that it is possible to curb the thickness of the mike substrate and it is possible to achieve the thin microphone unit 6.

Accordingly, according to the microphone unit in the present embodiment, it is possible to detect the sound-pressure difference by using the sound waves, as the inputs, at the two points on the cover portion 40, that is, at the first cover-portion opening portion 41 and the third cover-portion opening portion 43. Besides, by mounting a differential mike composed of one diaphragm with high density, it is possible to achieve a small-size, light-weight microphone unit.

Besides, a structure may be employed, in which the sound-wave arrival time from the first cover-portion opening portion 41 to the diaphragm 22 and the sound-wave arrival time from the third cover-portion opening portion 43 to the diaphragm 22 become equal to each other. To equalize the sound-wave arrival times to each other, a structure may be employed, in which for example, the sound-wave route length from the first cover-portion opening portion 41 to the diaphragm 22 and the sound-wave route length from the third cover-portion opening portion 43 to the diaphragm 22 become equal to each other. The route length may be, for example, the length of a line that connects the center of a section of the route. Preferably, the ratio of the route length is ±20% (a range of 80% or higher to 120% or lower) and equal, so that the acoustic impedances are nearly equal, and it is possible to improve a differential-mike characteristic in especially a high-frequency band.

According to this structure, it is possible to match the sound-wave arrival times, that is, the phases, from the first cover-portion opening portion 41 to the diaphragm 22 and from the third cover-portion opening portion 43 to the diaphragm 22 with each other and to achieve a higher-accuracy noise removal function.

The present invention covers substantially the same structure (e.g., a structure that has the same function, method and result or a structure that has the same purpose and effect) as the structures described in the embodiments. Besides, the present invention covers a structure in which an insubstantial portion in the structures described in the embodiments is replaced with another portion. Besides, the present invention covers a structure that is able to perform the same operation and effect or achieve the same purpose as the structures described in the embodiments. Besides, the present invention covers a structure in which prior art is added to the structures described in the embodiments.

For example, a structure is possible, in which the structure, like the microphone unit 1 described by using FIGS. 1A and 1B, which has an opening portion on one surface of the mike substrate and the structures, like the microphone unit 3 described by using FIGS. 7A and 7B and the microphone unit 6 described by using FIGS. 11A and 11B, which have the third opening portion on the other surface of the mike substrate are combined with each other.

Here, as for the microphone units 4 to 6 described in the fourth to sixth embodiments, preferably, the distance between the first cover-portion opening portion 41 and the third cover-portion opening portion 43 is set at 5.2 mm or shorter, so that it is possible to achieve a differential microphone that is excellent in a distant-noise curb characteristic.

Besides, by equalizing the area ratio of the first cover-portion opening portion 41 and the third cover-portion opening portion 43 within ±20% (a range of 80% or higher to 120% or lower), the acoustic impedances are nearly equal, and it is possible to improve the differential-mike characteristic in especially a high-frequency band.

Moreover, by equalizing the volume ratio of the sum of the volume of the substrate internal space 12 and the volume of the first cover-portion internal space 45 to the volume of the third cover-portion internal space 46 within ±50% (a range of 50% or higher to 150% or lower), the acoustic impedances are nearly equal, and it is possible to improve the differential-mike characteristic in especially a high-frequency band.

1. A microphone unit that includes a microphone substrate and a partition portion that has a diaphragm; and converts an input sound wave into an electrical signal by vibrating the diaphragm by means of a difference between sound pressures that act on both surfaces of the diaphragm; wherein the microphone substrate has a first substrate opening portion and a second substrate opening portion that are disposed on one surface;
the partition portion covers the first substrate opening portion;
the diaphragm covers at least part of the first substrate opening portion; and
an internal space, which is a space including at least a substrate internal space that is formed inside the microphone substrate; and communicates from the diaphragm to outside via the first substrate opening portion and the second substrate opening portion, is formed.

2. The microphone unit according to claim 1, wherein the substrate internal space is disposed in a vertical direction of a region that on both ends thereof, includes the first substrate opening portion and the second substrate opening portion.

3. The microphone unit according to claim 1, further comprising a cover portion that is put on a one-surface side of the microphone substrate; wherein
the cover portion has: a first cover-portion opening portion; a second cover-portion opening portion; a third cover-portion opening portion; a fourth cover-portion opening portion; a first cover-portion internal space that connects the first cover-portion opening portion and the second cover-portion opening portion to each other; and a second cover-portion internal space that connects the third cover-portion opening portion and the fourth cover-portion opening portion to each other;
the first cover-portion internal space communicates with the outside via the first cover-portion opening portion and with the internal space via the second cover-portion opening portion; and
the second cover-portion internal space communicates with the outside via the third cover-portion opening portion and partitioned from the internal space by the partition portion at at least part of the fourth cover-portion opening portion.

4. The microphone unit according to claim 1, wherein the microphone substrate is formed by attaching a plurality of substrates to each other in such a way that the substrate internal space is formed.

5. The microphone unit according to claim 1, wherein the microphone substrate has a third substrate opening portion disposed on the other surface; and
the internal space connects the diaphragm and the outside to each other via the third substrate opening portion besides the first substrate opening portion and the second substrate opening portion.

6. The microphone unit according to claim 5, wherein the substrate internal space is disposed in a vertical direction of the third substrate opening portion.

7. The microphone unit according to claim 5, further comprising a wiring substrate; wherein
the wiring substrate is disposed on a other-surface side of the microphone substrate and so joined to the other-side surface side as to cover the third substrate opening portion.

8. The microphone unit according to claim 3, wherein
a sound-wave arrival time from the first cover-portion opening portion to the diaphragm and a sound-wave arrival time from the third cover-portion opening portion to the diaphragm are equal to each other.

9. The microphone unit according to claim 3, further comprising a signal process circuit that is disposed on the one-surface side of the microphone substrate and in the second cover-portion internal space.
